(19) United States
(12) Patent Application Publication
(10) Pub. No.: US 2024/0389672 A1
(43) Pub. Date: Nov. 28, 2024

(54) AEROSOL-GENERATING DEVICE

(71) Applicant: KT&G CORPORATION, Daejeon (KR)

(72) Inventor: Youngbum KWON, Yongin-si Gyeonggi-do (KR)

(73) Assignee: KT&G CORPORATION, Daejeon (KR)

(21) Appl. No.: 18/667,277

(22) Filed: May 17, 2024

(30) Foreign Application Priority Data
May 25, 2023 (KR) 10-2023-0067795
Jul. 14, 2023 (KR) 10-2023-0091790

(51) Int. Cl. A24F 40/57; A24F 40/46; A24F 40/51; H05B 3/22

(52) U.S. Cl. CPC A24F 40/57; A24F 40/46; A24F 40/51; H05B 3/22

(57) ABSTRACT

An aerosol-generating device is disclosed. The aerosol-generating device includes a body, a heater disposed in the body and including a carbonaceous material, a power supply configured to supply power to the heater, and a controller configured to control power supplied to the heater. The controller determines the temperature of the heater based on the resistance value of the heater determined in a first section, and controls power supplied to the heater to heat the heater in a second section different from the first section.

### CROSS-REFERENCE TO RELATED APPLICATIONS

Pursuant to 35 U.S.C. § 119 (a), this application claims the benefit of earlier filing date and right of priority to Korean Patent Application Nos. 10-2023-0067795, filed on May 25, 2023 and 10-2023-0091790, filed on Jul. 14, 2023, the contents of which are all hereby incorporated by reference herein in their entirety.

### TECHNICAL FIELD

The present disclosure relates to an aerosol-generating device.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various studies on aerosol-generating devices have been conducted.

An aerosol-generating device generates an aerosol by heating an aerosol-generating substance using a heater. A conventional metal heater made of copper, constantan, or the like has a problem in that much time and power are consumed to generate heat to reach a temperature for generation of an aerosol.

A carbonaceous material such as carbon nanotubes or graphene has high thermal conductivity compared to conventional general metals. If a heater made of a carbonaceous material is applied to an aerosol-generating device, it may take only a few seconds or less to generate heat to reach a temperature for generation of an aerosol. However, because a heater made of a carbonaceous material exhibits a high temperature increase rate, a current or voltage applied to the heater may increase sharply, which may make a power supply circuit unstable. Further, there is a problem in that the heater is unnecessarily overheated to a temperature higher than necessary.

Therefore, it is very important to accurately measure the temperature of the heater in controlling the heater. However, if a voltage applied to the heater continuously varies or if the temperature of the heater rises rapidly, the conventional temperature sensor is not capable of accurately measuring the temperature of the heater.

### DISCLOSURE

### Technical Problem

It is an object of the present disclosure to solve the above and other problems.

It is another object of the present disclosure to provide an aerosol-generating device to which a heater made of a carbonaceous material is applied.

It is still another object of the present disclosure to provide an aerosol-generating device configured to derive the temperature of the heater by measuring the resistance of the heater in a section distinguished from a heating section of the heater.

### Technical Solution

In accordance with an aspect of the present disclosure, the above and other objects can be accomplished by the provision of an aerosol-generating device including a body, a heater disposed in the body and including a carbonaceous material, a power supply configured to supply power to the heater, and a controller configured to control power supplied to the heater, wherein the controller determines a temperature of the heater based on a resistance value of the heater determined in a first section, and controls power supplied to the heater to heat the heater in a second section different from the first section.

### ADVANTAGEOUS EFFECTS

According to at least one of embodiments of the present disclosure, since a heater made of a carbonaceous material is employed, it is possible to reduce a time required to heat the heater and to increase user satisfaction.

According to at least one of embodiments of the present disclosure, since the resistance of the heater is measured while applying a voltage having a constant magnitude to the heater, it is possible to accurately measure the temperature of the heater.

According to at least one of embodiments of the present disclosure, since the length of a section in which the temperature of the heater is measured is set to be short, it is possible to minimize the influence of measurement of the temperature of the heater on heating operation of the heater.

According to at least one of embodiments of the present disclosure, since a voltage having a constant magnitude applied to the heater is set corresponding to the voltage applied in a heater heating section, it is possible to minimize the influence of measurement of the temperature of the heater on heating operation of the heater.

According to at least one of embodiments of the present disclosure, since a heat diffusion part is disposed on the outer side of the heater, it is possible to diffuse heat generated unevenly from the heater and to reduce dissipation of the heat generated from the heater to the outside of the heater, thereby increasing the heating efficiency of an aerosol-generating device.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### DESCRIPTION OF DRAWINGS

The above and other objects, features and other advantages of the present disclosure will be more clearly understood from the following detailed description taken in conjunction with the accompanying drawings, in which:

FIGS. 1 to 4 are views showing aerosol-generating devices according to embodiments of the present disclosure;

FIG. 5 is a front perspective view of a heater of the aerosol-generating device according to an embodiment of the present disclosure;

FIG. 6 is a front perspective view of the heater shown in FIG. 5 with layers thereof unfolded;

FIGS. 7 and 8 are cross-sectional views of the heater shown in FIG. 5 and a heat diffusion part disposed thereon;

FIG. 9 is a circuit diagram of an aerosol-generating device according to an embodiment of the present disclosure;

FIG. 10 is a circuit diagram for measurement of resistance of the heater of the aerosol-generating device according to an embodiment of the present disclosure;

FIG. 11 is a flowchart illustrating heater temperature calculation and heater heating control of the aerosol-generating device according to an embodiment of the present disclosure;

FIGS. 12 to 14 are graphs illustrating a heating section and a temperature section of the aerosol-generating device according to an embodiment of the present disclosure; and

FIG. 15 is a block diagram of an aerosol-generating device according to an embodiment of the present disclosure.

### MODE FOR INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Throughout the present specification, the directions of an aerosol-generating device and a cartridge may be defined based on the orthogonal coordinate system. In the orthogonal coordinate system, the x-axis direction may be defined as a leftward-rightward direction of the aerosol-generating device and the cartridge. Here, based on the origin, the +x-axis direction may be the rightward direction, and the −x-axis direction may be the leftward direction. The y-axis direction may be defined as a forward-backward direction of the aerosol-generating device and the cartridge. Here, based on the origin, the +y-axis direction may be the backward direction, and the −y-axis direction may be the forward direction. The z-axis direction may be defined as an upward-downward direction of the aerosol-generating device and the cartridge. Here, based on the origin, the +z-axis direction may be the upward direction, and the −z-axis direction may be the downward direction.

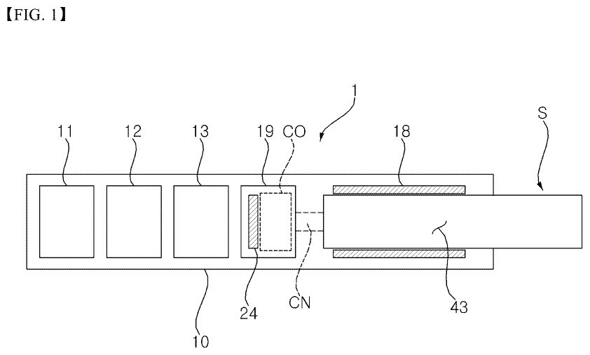

FIGS. 1 to 4 are views showing aerosol-generating devices 1 according to embodiments of the present disclosure.

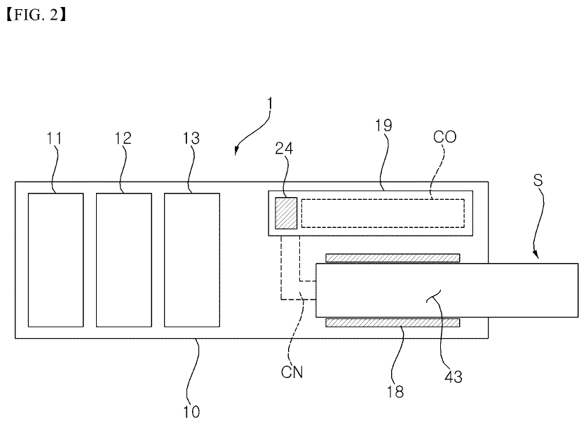

Referring to FIGS. 1 and 2, the aerosol-generating device 1 may include at least one of a power supply 11, a controller 12, a sensor 13, a heater 18, or a cartridge 19. At least one of the power supply 11, the controller 12, the sensor 13, or the heater 18 may be disposed in a body 10 of the aerosol-generating device. The body 10 may define a space having an open top to allow a stick S, which is an aerosol-generating article, to be inserted thereinto. The space having an open top may be referred to as an insertion space 43. The insertion space 43 may be formed so as to be depressed to a predetermined depth toward the interior of the body 10 so that the stick S is inserted at least partway thereinto. The depth of the insertion space 43 may correspond to the length of the portion of the stick S that contains an aerosol-generating substance and/or medium. The lower end of the stick S may be inserted into the body 10, and the upper end of the stick S may protrude to the outside of the body 10. A user may inhale air in a state of holding the upper end of the stick S, which is exposed to the outside, in the mouth.

The heater 18 may heat the stick S. The heater 18 may be disposed around the space into which the stick S is inserted and may be elongated upward. For example, the heater 18 may be formed in a shape of a tube including a cavity formed therein. The heater 18 may be disposed around the insertion space 43. The heater 18 may be disposed so as to surround at least a portion of the insertion space 43. The heater 18 may heat the insertion space 43 or the stick S inserted into the insertion space 43. The heater 18 may include an electro-resistive heater and/or an induction heater.

For example, the heater 18 may be a resistive heater. For example, the heater 18 may include an electrically conductive track and may be heated as current flows through the electrically conductive track. The heater 18 may be electrically connected to the power supply 11. The heater 18 may directly generate heat using current received from the power supply 11.

For example, the aerosol-generating device 1 may include an induction coil surrounding the heater 18. The induction coil may cause the heater 18 to generate heat. The heater 18 as a susceptor may generate heat using a magnetic field generated by alternating current flowing through the induction coil. The magnetic field may pass through the heater 18 to generate an eddy current in the heater 18. The current may cause the heater 18 to generate heat.

Meanwhile, a susceptor may be included in the stick S. The susceptor in the stick S may generate heat using a magnetic field generated by alternating current flowing through the induction coil.

The cartridge 19 may contain therein an aerosol-generating substance in a liquid state, a solid state, a gas state, or a gel state. The aerosol-generating substance may include a liquid composition. For example, the liquid composition may be a liquid including a tobacco-containing material including a volatile tobacco flavor component or may be a liquid including a non-tobacco material.

The cartridge 19 may be integrally formed with the body 10 or may be detachably coupled to the body 10.

For example, referring to FIG. 1, the cartridge 19 may be integrally formed with the body 10 and may communicate with the insertion space 43 through a gasflow channel CN.

For example, referring to FIG. 2, a space may be defined in one side of the body 10, and the cartridge 19 may be mounted in the body 10 in such a manner that at least a portion of the cartridge 19 is inserted into the space defined in one side of the body 10. The gasflow channel CN may be defined by a portion of the cartridge 19 and/or a portion of the body 10, and the cartridge 19 may communicate with the insertion space 43 through the gasflow channel CN.

The body 10 may be formed in a structure that allows outside air to be introduced into the body 10 in a state in which the cartridge 19 is inserted thereinto. In this case, the outside air introduced into the body 10 may pass through the cartridge 19 to enter the user's mouth.

The cartridge 19 may include a storage portion C0 containing an aerosol-generating substance and/or a heater 24 configured to heat the aerosol-generating substance in the storage portion C0. The storage portion C0 may be referred to as a container. At least a portion of a liquid delivery element impregnated with (containing) the aerosol-generating substance may be disposed in the storage portion C0. Here, the liquid delivery element may include a wick, such as cotton fiber, ceramic fiber, glass fiber, or porous ceramic. The electrically conductive track of the heater 24 may be formed in a coil-shaped structure that is wound around the liquid delivery element or a structure that is in contact with one side of the liquid delivery element. The heater 24 may be referred to as a cartridge heater 24.

The cartridge 19 may generate an aerosol. As the liquid delivery element is heated by the cartridge heater 24, an aerosol may be generated. An aerosol may be generated by heating the stick S using the heater 18. While the aerosol generated by the cartridge heater 24 and the heater 18 passes through the stick S, the aerosol may be mixed with a tobacco material, and the aerosol mixed with the tobacco material may be drawn into the user's mouth through one end of the stick S.

The aerosol-generating device 1 may be provided only with the cartridge heater 24, and the body 10 may not be provided with the heater 18. In this case, while the aerosol generated by the cartridge heater 24 passes through the stick S, the aerosol may be mixed with a tobacco material, and the aerosol mixed with the tobacco material may be drawn into the user's mouth.

The aerosol-generating device 1 may include an upper case (not shown). The upper case may be detachably coupled to the body 10 so as to cover at least a portion of the cartridge 19 coupled to the body 10. The stick S may be inserted into the body 10 through the upper case.

The power supply 11 may supply power so that components of the aerosol-generating device operate. The power supply 11 may be referred to as a battery. The power supply 11 may supply power to at least one of the controller 12, the sensor 13, the cartridge heater 24, or the heater 18. If the aerosol-generating device 1 includes an induction coil, the power supply 11 may supply power to the induction coil.

The controller 12 may control overall operation of the aerosol-generating device. The controller 12 may be mounted on a printed circuit board. The controller 12 may control operation of at least one of the power supply 11, the sensor 13, the heater 18, or the cartridge 19. The controller 12 may control operation of a display, a motor, etc. mounted in the aerosol-generating device. The controller 12 may check the state of each of the components of the aerosol-generating device and may determine whether the aerosol-generating device is in an operable state.

The controller 12 may analyze a result of detection by the sensor 13 and may control subsequent processes. For example, the controller 12 may control, based on a result of detection by the sensor 13, power supplied to the cartridge heater 24 and/or the heater 18 so that operation of the cartridge heater 24 and/or the heater 18 commences or ends. For example, the controller 12 may control, based on a result of detection by the sensor 13, the amount of power supplied to the cartridge heater 24 and/or the heater 18 and a power supply time so that the cartridge heater 24 and/or the heater 18 is heated to a predetermined temperature or is maintained at an appropriate temperature.

The sensor 13 may include at least one of a temperature sensor, a puff sensor, an insertion detection sensor, a color sensor, a cartridge detection sensor, or an upper case detection sensor. For example, the sensor 13 may detect at least one of the temperature of the heater 18, the temperature of the power supply 11, or the internal/external temperature of the body 10. For example, the sensor 13 may detect a user puff. For example, the sensor 13 may detect whether the stick S is inserted into the insertion space. For example, the sensor 13 may detect whether the cartridge is mounted. For example, the sensor 13 may detect whether the upper case is mounted.

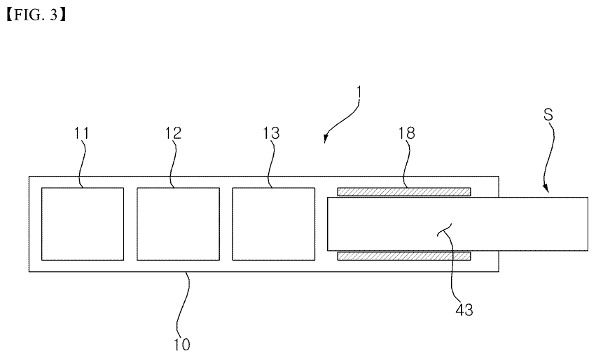

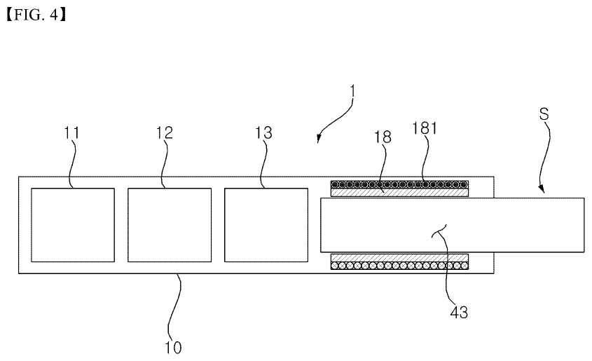

Referring to FIGS. 3 and 4, an aerosol-generating device 1 according to an embodiment may include at least one of a power supply 11, a controller 12, a sensor 13, or a heater 18. At least one of the power supply 11, the controller 12, the sensor 13, or the heater 18 may be disposed in a body 10 of the aerosol-generating device. A detailed description of the same configuration as that of the aerosol-generating device 1 shown in FIGS. 1 and 2 will be omitted.

The heater 18 may heat a stick S. The heater 18 may be disposed around a space into which the stick S is inserted and may be elongated upward. For example, the heater 18 may be formed in a shape of a tube including a cavity formed therein. The heater 18 may be disposed around an insertion space 43. The heater 18 may be disposed so as to surround at least a portion of the insertion space 43. The heater 18 may heat the insertion space 43 or the stick S inserted into the insertion space 43. The heater 18 may include an electro-resistive heater and/or an induction heater.

For example, referring to FIG. 3, the heater 18 may be a resistive heater. For example, the heater 18 may include an electrically conductive track and may be heated as current flows through the electrically conductive track. The heater 18 may be electrically connected to the power supply 11. The heater 18 may directly generate heat using current received from the power supply 11.

For example, referring to FIG. 4, the aerosol-generating device may include an induction coil 181 surrounding the heater 18. The induction coil 181 may cause the heater 18 to generate heat. The heater 18 as a susceptor may generate heat using a magnetic field generated by alternating current flowing through the induction coil 181. The magnetic field may pass through the heater 18 to generate an eddy current in the heater 18. The current may cause the heater 18 to generate heat.

Meanwhile, a susceptor may be included in the stick S, and the susceptor in the stick S may generate heat using a magnetic field generated by alternating current flowing through the induction coil 181.

The power supply 11 may supply power to at least one of the controller 12, the sensor 13, or the heater 18. If the aerosol-generating device 1 includes the induction coil 181, the power supply 11 may supply power to the induction coil 181.

The controller 12 may control operation of at least one of the power supply 11 or the sensor 13. The controller 12 may analyze a result of detection by the sensor 13 and may control subsequent processes. For example, the controller 12 may control, based on a result of detection by the sensor 13, power supplied to the heater 18 so that operation of the heater 18 commences or ends. For example, the controller 12 may control, based on a result of detection by the sensor 13, the amount of power supplied to the heater 18 and a power supply time so that the heater 18 is heated to a predetermined temperature or is maintained at an appropriate temperature.

The sensor 13 may include at least one of a temperature sensor, a puff sensor, or an insertion detection sensor. For example, the sensor 13 may detect at least one of the temperature of the heater 18, the temperature of the power supply 11, or the internal/external temperature of the body 10. For example, the sensor 13 may detect a user puff. For example, the sensor 13 may detect whether the stick S is inserted into the insertion space 43.

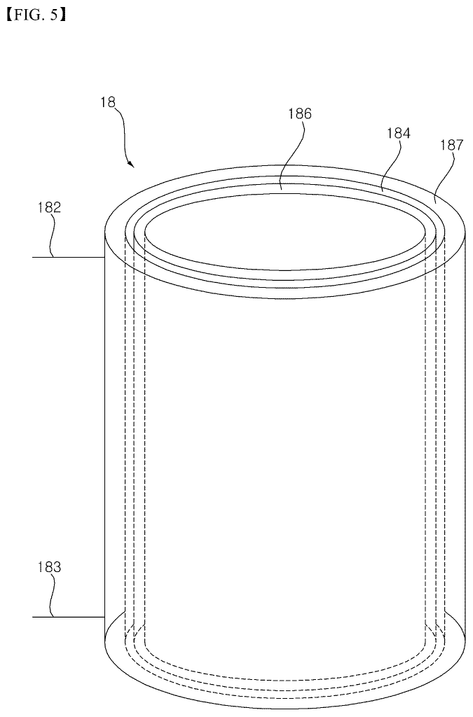

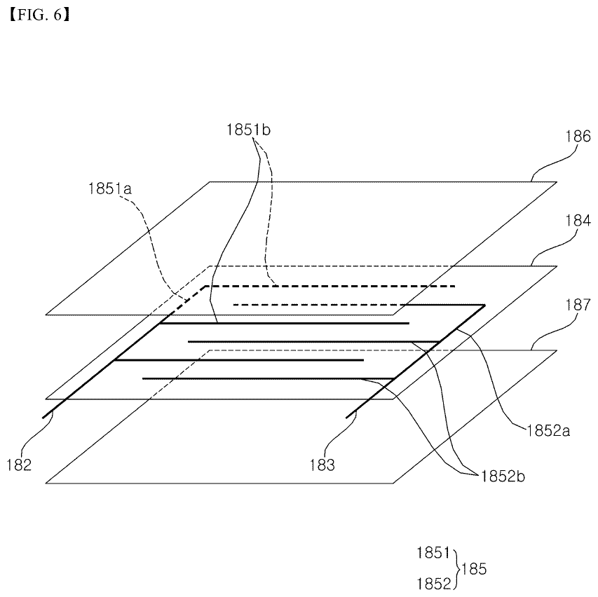

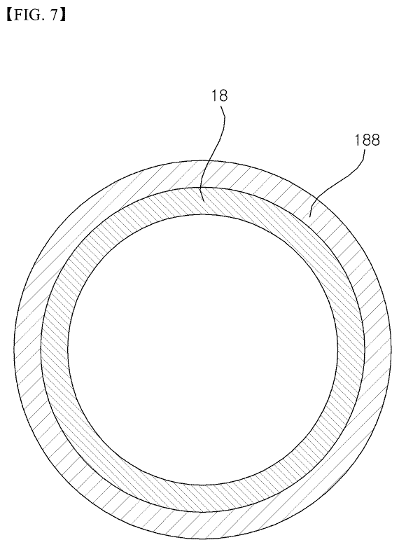

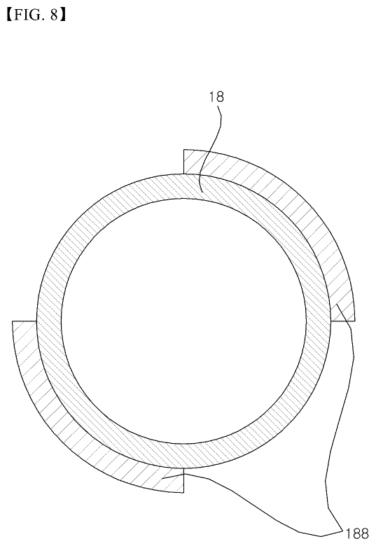

FIG. 5 is a front perspective view of a heater of the aerosol-generating device according to an embodiment of the present disclosure, FIG. 6 is a front perspective view of the heater shown in FIG. 5 with layers thereof unfolded, and FIGS. 7 and 8 are cross-sectional views of the heater shown in FIG. 5 and a heat diffusion part disposed thereon.

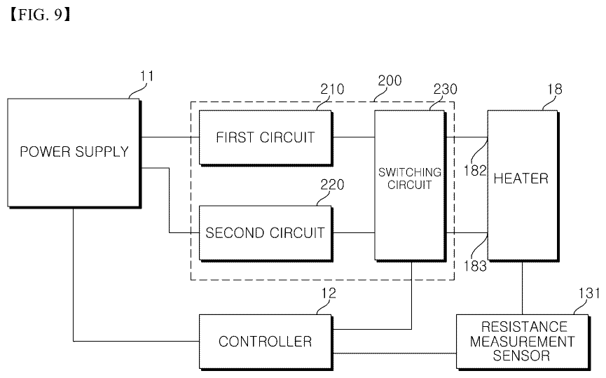

Referring to FIGS. 5 and 6, the heater 18 may be formed to be elongated. The heater 18 may be formed in a shape of a tube or a cylinder including a cavity formed therein. The heater 18 may be disposed in the body 10 of the aerosol-generating device 1. The heater 18 may surround the insertion space 43 (refer to FIGS. 1 to 4) in the body 10. The heater 18 may heat the insertion space 43 or the stick S inserted into the insertion space 43. The heater 18 may include two terminals 182 and 183 electrically connected to a heater driving circuit 200 (refer to FIG. 9).

The heater 18 may include a carbonaceous material. The carbonaceous material may include at least one of graphene or carbon nanotubes (CNT). Graphene and carbon nanotubes have high thermal and electrical conductivity. Therefore, the heater 18 containing graphene and/or carbon nanotubes has high heat generation efficiency, and the temperature of the heater 18 may rise quickly. In addition, graphene and carbon nanotubes are light in weight and have high flexibility, thus making it possible to obtain the lightweight heater 18 and to facilitate manufacture of the heater 18.

The heater 18 may include a carbon layer 184 containing a carbonaceous material and may include a first film 186 and a second film 187 that are in contact with both surfaces of the carbon layer 184, respectively. The carbon layer may be referred to as a graphene layer or a carbon nanolayer.

The carbon layer 184 may be manufactured using at least one of chemical vapor deposition, arc discharge, laser deposition, vapor growth, or flame synthesis.

An electrically conductive pattern 185 may be formed on the carbon layer 184. The electrically conductive pattern 185 may include two patterns spaced apart from each other. A first pattern 1851 of the electrically conductive pattern 185 may be connected at one end thereof to one end 182 of the heater 18. The end of the heater 18 may be referred to as a first terminal. The first pattern 1851 may include a first base pattern 1851a connected to the first terminal 182 and elongated in one direction. The first pattern 1851 may include a plurality of first extension patterns 1851b extending from the first base pattern 1851a in a direction intersecting the extension direction of the first base pattern and disposed so as to be spaced apart from each other.

A second pattern 1852 of the electrically conductive pattern 185 may be connected to the other end 183 of the heater 18. The other end of the heater 18 may be referred to as a second terminal. The second pattern 1852 may include a second base pattern 1852a connected to the second terminal 183 and elongated in one direction. The second pattern 1852 may include a plurality of second extension patterns 1852b extending from the second base pattern 1852a in a direction intersecting the extension direction of the second base pattern and disposed so as to be spaced apart from each other.

The plurality of first extension patterns 1851b and the plurality of second extension patterns 1852b may be alternately disposed so as to be spaced apart from each other in the extension direction of the first and second base patterns. The intervals by which the plurality of first extension patterns 1851b and the plurality of second extension patterns 1852b are spaced apart from each other in the extension direction of the first and second base patterns may be set to be uniform. However, the shape and arrangement of the plurality of first extension patterns 1851b and the plurality of second extension patterns 1852b are not limited thereto. Various shapes and arrangements may be applied to the plurality of first extension patterns 1851b and the plurality of second extension patterns 1852b, so long as the patterns are spaced apart from each other.

If voltages are applied to the first pattern 1851 and the second pattern 1852, the carbon layer 184 may generate heat in response to a difference between the voltages applied to the first pattern 1851 and the second pattern 1852.

The first film 186 may be disposed in contact with one surface of the carbon layer 184, and the second film 187 may be disposed in contact with the other surface of the carbon layer 184. The first film 186, the carbon layer 184, and the second film 187 may be stacked in that order. The first film 186 and the second film 187 may isolate the carbon layer 184 from the outside and may protect the carbon layer 184.

The first film 186 and the second film 187 may be polyimide films. However, the types of the first film 186 and the second film 187 are not limited thereto.

Referring to FIGS. 7 and 8, a heat diffusion part 188 may be disposed on the outer side of the heater 18. The heat diffusion part 188 may surround at least a portion of the tube-shaped or cylindrical heater 18. The heat diffusion part 188 may be in contact with at least a portion of the heater 18.

For example, referring to FIG. 7, the heat diffusion part 188 may surround the outer side of the heater 18. The heat diffusion part 188 may be a hollow graphite sheet. The graphite sheet may surround the outer side of the heater 18. The graphite sheet may be disposed in contact with the second film 187 of the heater 18 and may surround the outer side of the second film 187.

For example, referring to FIG. 8, the heat diffusion part 188 may surround at least a portion of the outer side of the heater 18. The heat diffusion part 188 may be provided in plural. The heat diffusion parts 188 may be spaced apart from each other along the periphery of the heater 18 and may be in contact with at least a portion of the outer side of the heater 18. The heat diffusion part 188 may be a vacuum tube or a heat pipe. The vacuum tube may include an inner space sealed from the outside. The inner space in the vacuum tube may be in a vacuum state. The heat pipe may include an inner space sealed from the outside. A material capable of transferring heat may be accommodated in the inner space in the heat pipe.

Since the heat diffusion part 188 is provided in contact with the cylindrical heater 18 while surrounding the heater 18, it is possible to evenly diffuse heat generated from the heater 18. In addition, it is possible to reduce dissipation of the heat generated from the heater 18 to the outside of the heater 18 and to guide the heat generated from the heater 18 to the inside of the heater 18.

Accordingly, the heating efficiency of the heater 18 may be increased.

FIG. 9 is a circuit diagram of an aerosol-generating device according to an embodiment of the present disclosure.

Referring to FIG. 9, the aerosol-generating device 1 may include at least one of a power supply 11, a controller 12, a heater 18, a resistance measurement sensor 131, or a heater driving circuit 200.

The heater 18 may be disposed in the body 10. The heater 18 may receive power from the power supply 11 to heat the insertion space 43 and/or the stick S inserted into the insertion space 43. The heater 18 may have the features of the heater 18 described above with reference to FIGS. 5 to 7.

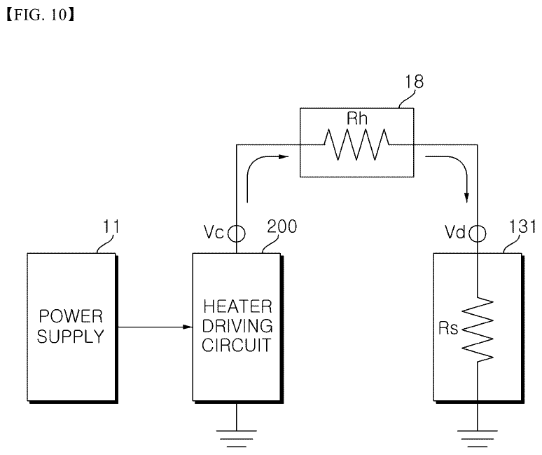

The resistance measurement sensor 131 may detect a current and/or voltage flowing through the heater 18. The resistance measurement sensor 131 may be disposed adjacent to the heater 18. The resistance measurement sensor 131 may be electrically connected to the heater 18. The resistance measurement sensor 131 may be connected in series to the heater 18. Operation of the resistance measurement sensor 131 will be described in detail later with reference to FIG. 10.

The power supply 11 may supply power to the heater 18. The power supply 11 may supply power to the heater 18 under the control of the controller 12.

The heater driving circuit 200 may be electrically connected to the heater 18, the power supply 11, and the controller 12. The heater driving circuit 200 may supply power output from the power supply 11 to the heater 18 under the control of the controller 12.

The heater driving circuit 200 may include a first circuit 210, a second circuit 220, and a switching circuit 230. The heater driving circuit 200 may apply voltages and/or currents to the two ends 182 and 183 of the heater 18 through the first circuit 210, the second circuit 220, and the switching circuit 230.

The first circuit 210 may convert the voltage output from the power supply 11. For example, the first circuit 210 may be implemented as a buck converter, a boost converter, or a buck-boost converter, which converts the voltage output from the power supply 11. The first circuit may be referred to as a converter or a power conversion circuit. The first circuit 210 may output a constant voltage. The first circuit 210 may convert the voltage output from the power supply 11 to output a voltage having a constant magnitude. For example, the magnitude of the voltage output from the first circuit 210 may be equal to or less than the magnitude of the voltage output from the power supply 11.

The second circuit 220 may output a pulse-type voltage under the control of the controller 12. The second circuit may be referred to as a PWM circuit or a power supply circuit. The controller 12 may control the power supplied to the heater 18 using a pulse width modulation (PWM) scheme. The controller 12 may control the second circuit 220 to supply a pulse having a predetermined frequency and duty ratio to the heater 18. The controller 12 may control the power supplied to the heater 18 by adjusting the frequency and/or duty ratio of the pulse through the second circuit 220.

The switching circuit 230 may be electrically connected to the first circuit 210, the second circuit 220, and the heater 18. The switching circuit 230 may electrically connect any one of the first circuit 210 and the second circuit 220 to the heater 18 under the control of the controller 12. The switching circuit 230 may supply the voltage and/or current output from any one of the first circuit 210 and the second circuit 220 to the heater 18.

The voltage output from the first circuit 210 may be applied to one end of the switching circuit 230. In this case, a first voltage Va applied across the two ends 182 and 183 of the heater 18 through the switching circuit 230 may be a voltage having a magnitude corresponding to the voltage output from the first circuit 210.

The voltage output from the second circuit 220 may be applied to one end of the switching circuit 230. In this case, the pulse output from the second circuit 220 may be applied across the two ends 182 and 183 of the heater 18 through the switching circuit 230.

The controller 12 may derive or determine the temperature of the heater 18. The controller 12 may derive or determine the temperature of the heater 18 based on a signal received from the resistance measurement sensor 131. The controller 12 may determine the power supplied to the heater 18 based on the derived or determined temperature of the heater 18. The controller 12 may control the power supply 11 to supply the determined power to the heater 18.

FIG. 10 is a circuit diagram for measurement of resistance of the heater of the aerosol-generating device according to an embodiment of the present disclosure.

Referring to FIG. 10, the resistance measurement sensor 131 may be configured as a sensor configured to detect the resistance value of the heater 18. The resistance measurement sensor may be referred to as a temperature sensor. The resistance measurement sensor 131 may output a signal corresponding to the resistance value of the heater 18.

The resistance measurement sensor 131 may be electrically connected to the heater 18. The heater driving circuit 200 may supply power to the heater 18 using the power stored in the power supply 11. The power supplied to the heater 18 from the heater driving circuit 200 may be adjusted under the control of the controller 12.

Currents having the same level may flow through the heater 18 and the resistance measurement sensor 131. A resistance value Rs of a shunt resistor provided in the resistance measurement sensor 131 may be a value that does not vary depending on temperature.

The controller 12 may determine a voltage Vc applied to the heater 18 and the resistance measurement sensor 131 based on the power supplied to the heater 18 from the heater driving circuit 200 and the current flowing through the heater 18 and the resistance measurement sensor 131. The controller 12 may calculate or determine a voltage Vd applied to the shunt resistor based on the current flowing through the shunt resistor of the resistance measurement sensor 131 and the resistance value Rs of the shunt resistor. The controller 12 may calculate or determine a difference (Vc−Vd) between the voltage Vc applied to the heater 18 and the resistance measurement sensor 131 and the voltage Vd applied to the shunt resistor as the voltage applied to the heater 18. The controller 12 may calculate or determine a resistance value Rh of the heater 18 based on the voltage applied to the heater 18 and the current flowing through the heater 18.

The resistor of the heater 18 may be a material having a temperature coefficient of resistance, and the resistance value Rh of the heater 18 may vary depending on the temperature of the resistor. The controller 12 may calculate or determine the temperature of the heater 18 corresponding to the resistance value of the heater 18 at a reference temperature using the temperature coefficient of resistance of the heater 18 and the resistance value Rh of the heater 18 based on a calculation formula for calculating the temperature of the heater 18. Here, the calculation formula for calculating the temperature of the heater 18 may correspond to Equation 1 below.

$$TCR = \frac{R 1 - R 0}{R 0} \div ( T 1 - T 0 ) \qquad [ Equation 1 ]$$

In Equation 1, TCR represents the temperature coefficient of resistance of the heater 18, T1 represents the temperature of the heater 18, R1 represents the resistance value of the heater 18, T0 represents the reference temperature, and R0 represents the resistance value of the heater 18 at the reference temperature. Here, T0 may be 25° C., and R0 may be the resistance value of the heater 18 at 25° C.

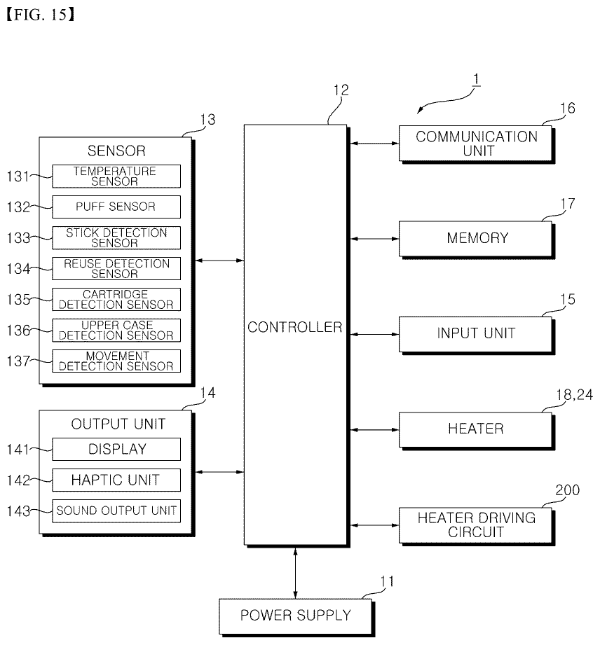

The resistance value of the heater 18 at the reference temperature may vary depending on aerosol-generating devices. In consideration thereof, data on the resistance value of the heater 18 and the like may be stored in a memory 17 (refer to FIG. 15) of the aerosol-generating device 1. The controller 12 may determine the resistance value R0 of the heater 18 at the reference temperature T0, which is used in the calculation formula for calculating the temperature of the heater 18, based on the data stored in the memory 17.

Meanwhile, although the resistance measurement sensor 131 connected in series to the heater 18 is illustrated in the drawing by way of example, the disclosure is not limited thereto. The resistance measurement sensor 131 may be implemented as a voltage sensor configured to detect the voltage applied to the heater 18.

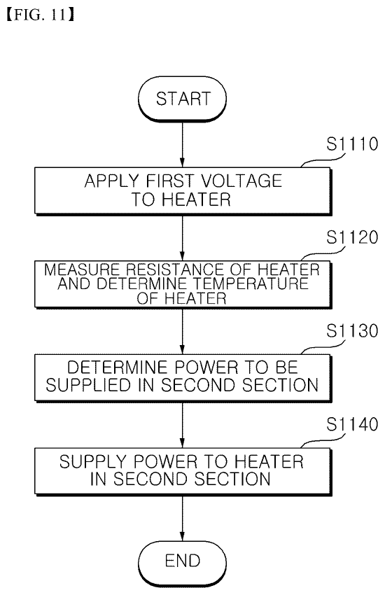

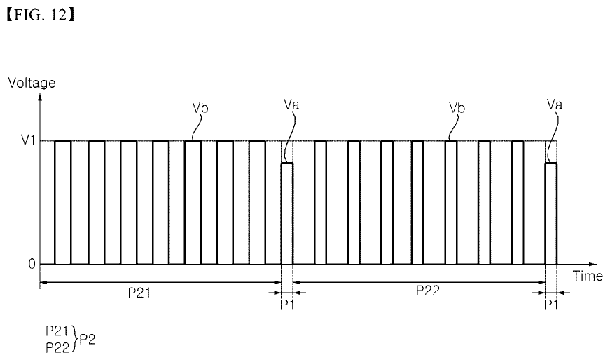

FIG. 11 is a flowchart illustrating heater temperature calculation and heater heating control of the aerosol-generating device according to an embodiment of the present disclosure, and FIGS. 12 to 14 are graphs illustrating control of a first section and a second section of the aerosol-generating device according to an embodiment of the present disclosure.

Referring to FIG. 11 together with FIG. 12, the controller 12 may control the heater 18. The operation of controlling the heater 18 by the controller 12 may include temperature measurement operation and heating control operation. The temperature measurement operation may be performed in a first section P1 (refer to FIG. 12), and the heating control operation may be performed in a second section P2 (refer to FIG. 12), which is different from the first section P1. The controller 12 may derive or determine the temperature of the heater 18 in the first section P1. The controller 12 may control the power supplied to the heater 18 in the second section P2 based on the temperature of the heater 18 derived or determined in the first section P1. The first section P1 and the second section P2 may be sections connected in time series. The first section P1 and the second section P2 may be alternately repeated.

In the first section P1, the controller 12 may control at least one of the power supply 11, the first circuit 210, or the switching circuit 230 to apply a first voltage Va (refer to FIG. 12) having a constant magnitude to the heater 18 (S1110).

In the first section P1, the controller 12 may control the switching circuit 230 to electrically connect the output terminal of the first circuit 210 to the two ends 182 and 183 of the heater 18. In the first section P1, the controller 12 may control the first circuit 210 to apply the voltage having a constant magnitude output from the first circuit 210 to the two ends 182 and 183 of the heater 18. Here, the voltage having a constant magnitude may be a voltage that does not change in magnitude throughout the first section P1.

The first voltage Va may correspond to the output voltage of the power supply 11. The first voltage Va may be equal to or lower than the output voltage of the power supply 11. For example, the first voltage Va may be 3.2 V or higher and 4.3 V or lower. Preferably, the first voltage Va may be about 3.8 V. The controller 12 may control the first circuit 210 to output the first voltage Va having a constant magnitude even when the output voltage of the power supply 11 varies.

In a state in which the first voltage Va having a constant magnitude is applied to the heater 18, the controller 12 may calculate or determine the resistance value of the heater 18 based on a signal received from the resistance measurement sensor 131, and may derive or determine the temperature of the heater 18 based thereon (S1120).

The controller 12 may determine power to be supplied to the heater 18 in a second section P22 subsequent to the first section P1 based on the temperature of the heater 18 derived or determined in the first section P1 (S1130). The controller 12 may compare the temperature of the heater 18 derived or determined in the first section P1 with a target temperature, and may determine power to be supplied to the heater 18 in the subsequent second section P22 based on a difference between the temperature of the heater 18 and the target temperature. For example, if the difference between the temperature of the heater 18 and the target temperature is greater than a reference value, the controller 12 may determine power to be supplied to the heater 18 in the subsequent second section P22 to be greater than the power supplied to the heater in the second section P21 prior to the current first section P1. For example, if the difference between the temperature of the heater 18 and the target temperature is equal to the reference value, the controller 12 may determine power to be supplied to the heater 18 in the subsequent second section P22 to be equal to the power supplied to the heater in the second section P21 prior to the current first section P1. For example, if the difference between the temperature of the heater 18 and the target temperature is less than the reference value, the controller 12 may determine power to be supplied to the heater 18 in the subsequent second section P22 to be less than the power supplied to the heater in the second section P21 prior to the current first section P1.

The controller 12 may supply the determined power to the heater 18 in the subsequent second section P22 (S1140). The controller 12 may determine a duty ratio or a duty cycle for PWM control of the subsequent second section P22 based on the determined power. The controller 12 may control at least one of the power supply 11, the second circuit 220, or the switching circuit 230 to apply a second voltage Vb (refer to FIG. 12) to the heater 18. The controller 12 may control the switching circuit 230 to electrically connect the output terminal of the second circuit 220 to the two ends 182 and 183 of the heater 18. In the subsequent second section P22, the controller 12 may control the second circuit 220 to supply a pulse having a predetermined frequency and duty ratio to the heater 18.

The controller 12 may repeatedly perform the operation of supplying power to the heater 18 in the subsequent second section P2 based on the temperature of the heater 18 derived or determined in the first section P1.

Because the voltage Vb applied to the heater 18 varies in the form of a pulse in the second section P2, if the temperature of the heater 18 is measured in the second section P2, accuracy of the measured temperature may be low. According to the aerosol-generating device 1 according to an embodiment of the present disclosure, the temperature of the heater 18 is measured in the first section P1, which is different from the second section P2 in which the heater is heated, and the temperature of the heater 18 is measured while applying a constant voltage having a constant magnitude to the heater 18, with a result that accuracy of the measured temperature of the heater may be increased.

The length of the second section P2 may be set to be longer than the length of the first section P1. For example, a ratio of the length of the second section P2 to the length of the first section P1 may be greater than 50:1. Preferably, the ratio of the length of the second section P2 to the length of the first section P1 may be 99:1. For example, the length of the second section P2 may be set to 990 ms, and the length of the first section P1 may be set to 10 ms.

The power applied in the first section P1 for deriving the temperature of the heater 18 and the power applied in the second section P2 for heating the heater 18 may be different from each other. Therefore, the length of the first section P1 is set to be shorter than the length of the second section P2, thereby reducing the influence of the heater temperature measurement section on heating of the heater 18.

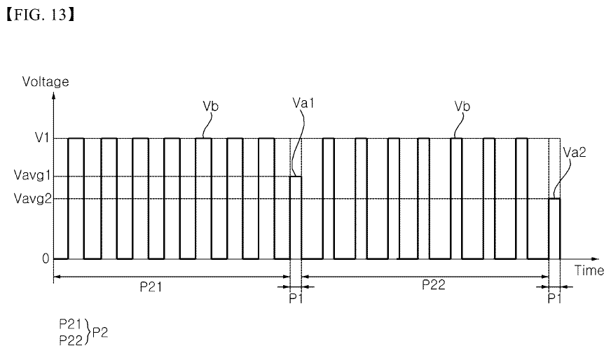

Referring to FIG. 13, the controller 12 may determine the magnitude of the first voltage Va before applying the first voltage Va to the heater 18. The controller 12 may determine the first voltage Va1 based on the power supplied to the heater 18 in the second section P21 prior to the first section P1.

The controller 12 may calculate or determine an average voltage Vavg1 applied to the heater 18 in the second section P21 prior to the first section P1. The controller 12 may calculate or determine the average voltage Vavg1 applied to the heater 18 in the previous second section P21 based on the frequency and/or duty ratio of the pulse applied to the heater 18 in the previous second section P21.

The controller 12 may determine the first voltage Va1 based on the calculated or determined average voltage Vavg1. For example, the controller 12 may determine a voltage having a magnitude equal or similar to the magnitude of the calculated or determined average voltage Vavg1 to be the first voltage Va1.

In the first section P1, the controller 12 may apply the determined first voltage Va1 to the heater 18, and may calculate or determine the temperature of the heater 18. The controller 12 may determine power to be supplied to the heater 18 in a subsequent second section P22 based on the temperature of the heater 18, and may supply the power to the heater 18.

Similarly, the controller 12 may calculate or determine an average voltage Vavg2 applied to the heater 18 in the subsequent second section P22, and may determine the magnitude of a first voltage Va2 to be applied in a subsequent first section P1 based thereon. The controller 12 may apply the first voltage Va2 to the heater 18 in the subsequent first section P1, and may calculate or determine the temperature of the heater 18. The operation of determining power supplied to the heater 18 and supplying the power to the heater 18 by the controller 12 is identical to that described above with reference to FIG. 12, and thus a detailed description thereof will be omitted.

Because the first voltage Va applied in the first section P1 is determined corresponding to the average voltage Vavg applied in the previous second section P2, it is possible to reduce the influence of the heater temperature measurement section on heating of the heater 18.

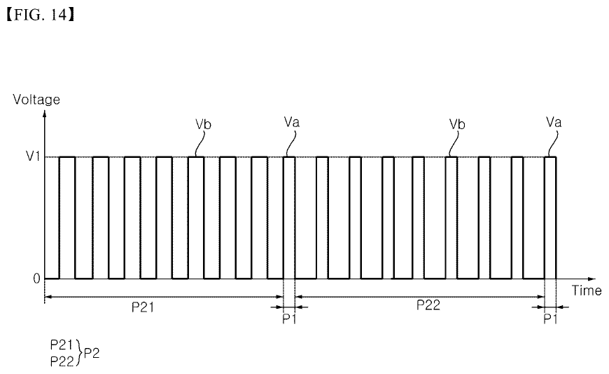

Referring to FIG. 14, the heater driving circuit 200 of the aerosol-generating device 1 according to another embodiment of the present disclosure may include a second circuit 220, and may include neither a first circuit 210 nor a switching circuit 230.

In the first section P1, the controller 12 may control the second circuit 220 to apply the first voltage Va to the two ends 182 and 183 of the heater 18. The controller 12 may perform control so that the duty ratio of the pulse output from the second circuit 220 is 100%. That is, the controller 12 may perform control so that a voltage having a constant magnitude is output from the second circuit 220 during the first section P1.

In the first section P1, the controller 12 may apply the first voltage Va to the heater 18, and may calculate or determine the temperature of the heater 18. The operation of determining power supplied to the heater 18 and supplying the power to the heater 18 by the controller 12 is identical to that described above with reference to FIG. 12, and thus a detailed description thereof will be omitted.

As described above, the duty ratio of the pulse output from the second circuit 220 is adjusted so that a voltage having a constant magnitude is applied during the first section P1, whereby the heater driving circuit may be simplified.

FIG. 15 is a block diagram of an aerosol-generating device 1 according to an embodiment of the present disclosure.

The aerosol-generating device 1 may include a power supply 11, a controller 12, a sensor 13, an output unit 14, an input unit 15, a communication unit 16, a memory 17, and one or more heaters 18 and 24. However, the internal structure of the aerosol-generating device 1 is not limited to that shown in FIG. 15. That is, it is to be understood by those skilled in the art that some of the components shown in FIG. 15 may be omitted or new components may be added depending on the design of the aerosol-generating device 1.

The sensor 13 may detect the state of the aerosol-generating device 1 or the state of the surrounding of the aerosol-generating device 1 and may transmit information about the detected state to the controller 12. Based on the information about the detected state, the controller 12 may control the aerosol-generating device 1 to perform various functions, such as control of operation of the cartridge heater 24 and/or the heater 18, smoking restriction, determination as to whether the stick S and/or the cartridge 19 is inserted, and notification display.

The sensor 13 may include at least one of a temperature sensor 131, a puff sensor 132, an insertion detection sensor 133, a reuse detection sensor 134, a cartridge detection sensor 135, an upper case detection sensor 136, a movement detection sensor 137, or a humidity sensor 138.

The temperature sensor 131 may detect temperature to which the cartridge heater 24 and/or the heater 18 is heated. The aerosol-generating device 1 may include a separate temperature sensor configured to detect the temperature of the cartridge heater 24 and/or the heater 18, or the cartridge heater 24 and/or the heater 18 itself may serve as a temperature sensor.

The temperature sensor 131 may output a signal corresponding to the temperature of the cartridge heater 24 and/or the heater 18. For example, the temperature sensor 131 may include a resistive element that changes in resistance value according to a change in temperature of the cartridge heater 24 and/or the heater 18. The temperature sensor may be implemented as a thermistor, which is an element characterized in that the resistance thereof changes with temperature. In this case, the temperature sensor 131 may output a signal corresponding to the resistance value of the resistive element as a signal corresponding to the temperature of the cartridge heater 24 and/or the heater 18. For example, the temperature sensor 131 may be configured as a sensor configured to detect the resistance value of the cartridge heater 24 and/or the heater 18. In this case, the temperature sensor 131 may output a signal corresponding to the resistance value of the cartridge heater 24 and/or the heater 18 as a signal corresponding to the temperature of the cartridge heater 24 and/or the heater 18.

The temperature sensor 131 may be disposed around the power supply 11 to monitor the temperature of the power supply 11. The temperature sensor 131 may be disposed adjacent to the power supply 11. For example, the temperature sensor 131 may be attached to one surface of the battery, which is the power supply 11. For example, the temperature sensor 131 may be mounted on one surface of a printed circuit board.

The temperature sensor 131 may be disposed in the body 10 to detect the internal temperature of the body 10.

The puff sensor 132 may detect a user puff based on various physical changes in a gasflow path. The puff sensor 132 may output a signal corresponding to a puff. For example, the puff sensor 132 may be a pressure sensor. The puff sensor 132 may output a signal corresponding to the internal pressure of the aerosol-generating device. Here, the internal pressure of the aerosol-generating device 1 may correspond to the pressure of the gasflow path through which gas flows. The puff sensor 132 may be disposed at a position corresponding to the gasflow path through which gas flows in the aerosol-generating device 1.

The stick detection sensor 133 may detect insertion and/or removal of the stick S. The stick detection sensor may be referred to as an insertion detection sensor. The insertion detection sensor 133 may detect a signal change caused by insertion and/or removal of the stick S. The insertion detection sensor 133 may be mounted around the insertion space. The insertion detection sensor 133 may detect insertion and/or removal of the stick S according to a change in dielectric constant in the insertion space. For example, the insertion detection sensor 133 may be an inductive sensor and/or a capacitance sensor.

The inductive sensor may include at least one coil. The coil of the inductive sensor may be disposed adjacent to the insertion space. For example, if a magnetic field changes around a coil through which current flows, the characteristics of the current flowing through the coil may change according to Faraday's law of electromagnetic induction. Here, the characteristics of the current flowing through the coil may include a frequency of alternating current, a current value, a voltage value, an inductance value, an impedance value, and the like.

The inductive sensor may output a signal corresponding to the characteristics of the current flowing through the coil. For example, the inductive sensor may output a signal corresponding to the inductance value of the coil.

The capacitance sensor may include a conductive body. The conductive body of the capacitance sensor may be disposed adjacent to the insertion space. The capacitance sensor may output a signal corresponding to the electromagnetic characteristics of the surroundings, for example, the capacitance around the conductive body. For example, if the stick S including a metallic wrapper is inserted into the insertion space, the electromagnetic characteristics around the conductive body may change due to the wrapper of the stick S.

The reuse detection sensor 134 may detect whether the stick S is being reused. The reuse detection sensor 134 may be a color sensor. The color sensor may detect the color of the stick S. The color sensor may detect the color of a portion of the wrapper surrounding the outer side of the stick S. The color sensor may detect, based on light reflected from an object, a value for the optical characteristic corresponding to the color of the object. For example, the optical characteristic may be the wavelength of light. The color sensor may be implemented as a component integrated with a proximity sensor or may be implemented as a component provided separately from a proximity sensor.

At least a portion of the wrapper constituting the stick S may change in color due to an aerosol. The reuse detection sensor 134 may be disposed at a position corresponding to a position at which at least a portion of the wrapper, which changes in color due to an aerosol, is disposed when the stick S is inserted into the insertion space. For example, before the stick S is used by the user, the color of at least a portion of the wrapper may be a first color. In this case, while the aerosol generated by the aerosol-generating device 1 passes through the stick S, at least a portion of the wrapper may become wet due to the aerosol, and accordingly, the color of at least a portion of the wrapper may change to a second color. After changing from the first color to the second color, the color of at least a portion of the wrapper may be maintained in the second color.

The cartridge detection sensor 135 may detect mounting and/or removal of the cartridge 19. The cartridge detection sensor 135 may be implemented as an inductance-based sensor, a capacitive sensor, a resistance sensor, a Hall sensor (or Hall IC) using the Hall effect, etc.

The upper case detection sensor 136 may detect mounting and/or removal of the upper case. When the upper case is separated from the body 10, the cartridge 19 and the portion of the body 10 that have been covered by the upper case may be exposed to the outside. The upper case detection sensor 136 may be implemented as a contact sensor, a Hall sensor (or Hall IC), an optical sensor, etc.

The movement detection sensor 137 may detect movement of the aerosol-generating device. The movement detection sensor 137 may be implemented as at least one of an acceleration sensor or a gyro sensor.

The humidity sensor 138 may detect the humidity of the aerosol-generating device and/or the cartridge. The humidity sensor 138 may detect the humidity of outside air and/or the humidity in the cartridge. The humidity sensor 138 may be implemented as a capacitive sensor or the like. The humidity sensor 138 may be disposed on the outer side of the body 10 or may be located in a path through which outside air is introduced to measure the humidity of the surroundings of the aerosol-generating device 1. The humidity sensor 138 may be located in the storage portion C0 of the cartridge 19 to measure the humidity in the cartridge 19.

In addition to the sensors 131 to 138 described above, the sensor 13 may further include at least one of a barometric pressure sensor, a magnetic sensor, a position sensor (GPS), or a proximity sensor. The functions of the sensors could be intuitively deduced by those skilled in the art from the names thereof, and thus detailed descriptions thereof will be omitted.

The output unit 14 may output information about the state of the aerosol-generating device 1 and may provide the information to the user. The output unit 14 may include at least one of a display 141, a haptic unit 142, or a sound output unit 143. However, the disclosure is not limited thereto. If the display 141 and a touchpad form a touchscreen together in a layered structure, the display 141 may be used as not only an output device but also an input device.

The display 141 may visually provide information about the aerosol-generating device 1 to the user. For example, the information about the aerosol-generating device 1 may include various pieces of information, such as a charging/discharging state of the power supply 11 of the aerosol-generating device 1, a preheating state of the heater 18, an insertion/removal state of the stick S and/or the cartridge 19, a mounting/removal state of the upper case, and a use restriction state of the aerosol-generating device 1 (e.g., detection of an abnormal article), and the display 141 may output the information to the outside. For example, the display 141 may be in the form of a light-emitting diode (LED) device. For example, the display 141 may be a liquid crystal display panel (LCD), an organic light-emitting display panel (OLED), or the like.

The haptic unit 142 may convert an electrical signal into mechanical stimulation or electrical stimulation to haptically provide the information about the aerosol-generating device 1 to the user. For example, if initial power is supplied to the cartridge heater 24 and/or the heater 18 for a predetermined amount of time, the haptic unit 142 may generate vibration corresponding to completion of initial preheating. The haptic unit 142 may include a vibration motor, a piezoelectric element, or an electrical stimulation device.

The sound output unit 143 may audibly provide information about the aerosol-generating device 1 to the user. For example, the sound output unit 143 may convert an electrical signal into an acoustic signal and may output the acoustic signal to the outside.

The power supply 11 may supply power used for operation of the aerosol-generating device 1. The power supply 11 may supply power so that the cartridge heater 24 and/or the heater 18 is heated. In addition, the power supply 11 may supply power necessary for operation of the other components provided in the aerosol-generating device 1, such as the sensor 13, the output unit 14, the input unit 15, the communication unit 16, and the memory 17. The power supply 11 may be a rechargeable battery or a disposable battery. For example, the power supply 11 may be a lithium polymer (LiPoly) battery. However, the disclosure is not limited thereto.

Although not shown in FIG. 15, the aerosol-generating device 1 may further include a power supply protection circuit. The power supply protection circuit may be electrically connected to the power supply 11 and may include a switching element.

The power supply protection circuit may block an electric path to the power supply 11 according to a predetermined condition. For example, the power supply protection circuit may block the electric path to the power supply 11 when the voltage level of the power supply 11 is equal to or higher than a first voltage corresponding to overcharge. For example, the power supply protection circuit may block the electric path to the power supply 11 when the voltage level of the power supply 11 is lower than a second voltage corresponding to overdischarge.

The heater 18 may receive power from the power supply 11 to heat the medium or the aerosol-generating substance in the stick S. Although not shown in FIG. 15, the aerosol-generating device 1 may further include a power conversion circuit (e.g., DC-to-DC converter) configured to convert the power of the power supply 11 and supply the converted power to the cartridge heater 24 and/or the heater 18. In addition, if the aerosol-generating device 1 generates an aerosol in an induction heating way, the aerosol-generating device 1 may further include a DC-to-AC converter configured to convert direct current power of the power supply 11 into alternating current power.

The controller 12, the sensor 13, the output unit 14, the input unit 15, the communication unit 16, and the memory 17 may perform functions using power received from the power supply 11. Although not shown in FIG. 15, the aerosol-generating device may further include a power conversion circuit configured to convert the power of the power supply 11 and supply the converted power to the respective components, for example, a low dropout (LDO) circuit or a voltage regulator circuit. In addition, although not shown in FIG. 15, a noise filter may be provided between the power supply 11 and the heater 18. The noise filter may be a low-pass filter. The low-pass filter may include at least one inductor and a capacitor. The cutoff frequency of the low-pass filter may correspond to the frequency of a high-frequency switching current applied from the power supply 11 to the heater 18. The low-pass filter may prevent high-frequency noise components from being applied to the sensor 13, for example, the insertion detection sensor 133.

In an embodiment, the cartridge heater 24 and/or the heater 18 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome. However, the disclosure is not limited thereto. In addition, the heater 18 may be implemented as a metal wire, a metal plate on which an electrically conductive track is disposed, or a ceramic heating element. However, the disclosure is not limited thereto.

In another embodiment, the heater 18 may be an induction heater. For example, the heater 18 may include a susceptor configured to generate heat through a magnetic field applied by a coil, thereby heating the aerosol-generating substance.

The input unit 15 may receive information input from the user or may output information to the user. For example, the input unit 15 may be a touch panel. The touch panel may include at least one touch sensor configured to detect touch. For example, the touch sensor may include a capacitive touch sensor, a resistive touch sensor, a surface acoustic wave touch sensor, an infrared touch sensor, etc. However, the disclosure is not limited thereto.

The display 141 and the touch panel may be implemented as an integrated panel. For example, the touch panel may be inserted into the display 141 (on-cell type touch panel or in-cell type touch panel). For example, the touch panel may be added onto the display 141 (add-on type touch panel).

Meanwhile, the input unit 15 may include a button, a keypad, a dome switch, a jog wheel, a jog switch, etc. However, the disclosure is not limited thereto.

The memory 17 may be hardware storing various pieces of data processed in the aerosol-generating device 1. The memory 17 may store data processed and to be processed by the controller 12. The memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. The memory 17 may store data on an operation time of the aerosol-generating device 1, the maximum number of puffs, the current number of puffs, at least one temperature profile, and the user's smoking pattern.

The communication unit 16 may include at least one component for communication with other electronic devices. For example, the communication unit 16 may include at least one of a short-range communication unit or a wireless communication unit.

The short-range communication unit may include a Bluetooth communication unit, a Bluetooth low energy (BLE) communication unit, a near-field communication unit, a WLAN (Wi-Fi) communication unit, a Zigbee communication unit, an infrared data association (IrDA) communication unit, a Wi-Fi direct (WFD) communication unit, an ultra-wideband (UWB) communication unit, an Ant+ communication unit, etc. However, the disclosure is not limited thereto.

The wireless communication unit may include a cellular network communication unit, an Internet communication unit, a computer network (e.g., LAN or WAN) communication unit, etc. However, the disclosure is not limited thereto.

Although not shown in FIG. 15, the aerosol-generating device 1 may further include a connection interface such as a universal serial bus (USB) interface, and may be connected to other external devices through the connection interface such as a USB interface to transmit and receive information or charge the power supply 11.

The controller 12 may control overall operation of the aerosol-generating device 1. In an embodiment, the controller 1 may include at least one processor. The processor may be implemented as an array of a plurality of logic gates or may be implemented as a combination of a general-purpose microprocessor and a memory in which a program executable in the microprocessor is stored. Also, it will be understood by those skilled in the art that the processor can be implemented in other forms of hardware.

The controller 12 may control the supply of power from the power supply 11 to the heater 18 to control the temperature of the heater 18. The controller 12 may control the temperature of the cartridge heater 24 and/or the heater 18 based on the temperature of the cartridge heater 24 and/or the heater 18 detected by the temperature sensor 131. The controller 12 may control the power supplied to the cartridge heater 24 and/or the heater 18 based on the temperature of the cartridge heater 24 and/or the heater 18. For example, the controller 12 may determine a target temperature of the cartridge heater 24 and/or the heater 18 based on the temperature profile stored in the memory 17.

The aerosol-generating device 1 may include a power supply circuit (not shown) electrically connected to the power supply 11 between the power supply 11 and the cartridge heater 24 and/or the heater 18. The power supply circuit may be electrically connected to the cartridge heater 24, the heater 18, or the induction coil 181. The power supply circuit may include at least one switching element. The switching element may be implemented as a bipolar junction transistor (BJT), a field effect transistor (FET), or the like. The controller 12 may control the power supply circuit.

The controller 12 may control switching of the switching element of the power supply circuit to control the supply of power. The power supply circuit may be an inverter configured to convert direct current power output from the power supply 11 into alternating current power. For example, the inverter may be composed of a full-bridge circuit or a half-bridge circuit including a plurality of switching elements.

The controller 12 may turn on the switching element so that power is supplied from the power supply 11 to the cartridge heater 24 and/or the heater 18. The controller 12 may turn off the switching element so that the supply of power to the cartridge heater 24 and/or the heater 18 is interrupted. The controller 12 may control the frequency and/or the duty ratio of the current pulse input to the switching element to control the current supplied from the power supply 11.

The controller 12 may control switching of the switching element of the power supply circuit to control the voltage output from the power supply 11. The power conversion circuit may convert the voltage output from the power supply 11. For example, the power conversion circuit may include a buck-converter configured to step down the voltage output from the power supply 11. For example, the power conversion circuit may be implemented as a buck-boost converter, a Zener diode, or the like.

The controller 12 may control on/off operation of the switching element included in the power conversion circuit to control the level of the voltage output from the power conversion circuit. If the switching element is maintained in an on state, the level of the voltage output from the power conversion circuit may correspond to the level of the voltage output from the power supply 11. The duty ratio for the on/off operation of the switching element may correspond to a ratio of the voltage output from the power conversion circuit to the voltage output from the power supply 11. As the duty ratio for the on/off operation of the switching element decreases, the level of the voltage output from the power conversion circuit may decrease. The heater 18 may be heated based on the voltage output from the power conversion circuit.

The controller 12 may control the supply of power to the heater 18 using at least one of a pulse width modulation (PWM) scheme or a proportional-integral-differential (PID) scheme.

For example, the controller 12 may perform control using the PWM scheme such that a current pulse having a predetermined frequency and a predetermined duty ratio is supplied to the heater 18. The controller 12 may control the frequency and the duty ratio of the current pulse to control the power supplied to the heater 18.

For example, the controller 12 may determine, based on the temperature profile, a target temperature to be controlled. The controller 12 may control the power supplied to the heater 18 using the PID scheme, which is a feedback control scheme using a difference value between the temperature of the heater 18 and the target temperature, a value obtained by integrating the difference value with respect to time, and a value obtained by differentiating the difference value with respect to time.

The controller 12 may prevent the cartridge heater 24 and/or the heater 18 from overheating. For example, the controller 12 may control operation of the power conversion circuit such that the supply of power to the cartridge heater 24 and/or the heater 18 is interrupted when the temperature of the cartridge heater 24 and/or the heater 18 exceeds a predetermined limit temperature. For example, the controller 12 may reduce the amount of power supplied to the cartridge heater 24 and/or the heater 18 by a predetermined ratio when the temperature of the cartridge heater 24 and/or the heater 18 exceeds a predetermined limit temperature. For example, when the temperature of the cartridge heater 24 exceeds a limit temperature, the controller 12 may determine that the aerosol-generating substance contained in the cartridge 19 has been exhausted and may interrupt the supply of power to the cartridge heater 24.

The controller 12 may control charging/discharging of the power supply 11. The controller 12 may check the temperature of the power supply 11 based on an output signal from the temperature sensor 131.

If a power line is connected to a battery terminal of the aerosol-generating device 1, the controller 12 may determine whether the temperature of the power supply 11 is equal to or higher than a first limit temperature, which is a reference temperature at which charging of the power supply 11 is interrupted. When the temperature of the power supply 11 is lower than the first limit temperature, the controller 12 may perform control such that the power supply 11 is charged based on a predetermined charging current. When the temperature of the power supply 11 is equal to or higher than the first limit temperature, the controller 12 may interrupt charging of the power supply 11.

When the aerosol-generating device 1 is in an on state, the controller 12 may determine whether the temperature of the power supply 11 is equal to or higher than a second limit temperature, which is a reference temperature at which discharging of the power supply 11 is interrupted. When the temperature of the power supply 11 is lower than the second limit temperature, the controller 12 may perform control such that the power stored in the power supply 11 is used. When the temperature of the power supply 11 is equal to or higher than the second limit temperature, the controller 12 may interrupt use of the power stored in the power supply 11.

The controller 12 may calculate or determine the remaining amount of power stored in the power supply 11. For example, the controller 12 may calculate or determine the remaining capacity of the power supply 11 based on a voltage and/or current detection value of the power supply 11.

The controller 12 may determine whether the stick S is inserted into the insertion space using the insertion detection sensor 133. The controller 12 may determine that the stick S has been inserted based on an output signal from the insertion detection sensor 133. Upon determining that the stick S has been inserted into the insertion space, the controller 12 may perform control such that power is supplied to the cartridge heater 24 and/or the heater 18. For example, the controller 12 may supply power to the cartridge heater 24 and/or the heater 18 based on the temperature profile stored in the memory 17.

The controller 12 may determine whether the stick S is removed from the insertion space. For example, the controller 12 may determine whether the stick S is removed from the insertion space using the insertion detection sensor 133. For example, the controller 12 may determine that the stick S has been removed from the insertion space when the temperature of the heater 18 is equal to or higher than a limit temperature or when the temperature change slope of the heater 18 is equal to or greater than a predetermined slope. Upon determining that the stick S has been removed from the insertion space, the controller 12 may interrupt the supply of power to the cartridge heater 24 and/or the heater 18.

The controller 12 may control a power supply time and/or the amount of power supplied to the heater 18 depending on the state of the stick S detected by the sensor 13. The controller 12 may check, based on a look-up table, a level range within which the level of a signal from the capacitance sensor is included. The controller 12 may determine the amount of moisture in the stick S based on the checked level range.

When the stick S is in a highly humid state, the controller 12 may control a time during which power is supplied to the heater 18 to increase a preheating time of the stick S compared to when the stick S is in a normal state.

The controller 12 may determine whether the stick S inserted into the insertion space is a reused stick using the reuse detection sensor 134. For example, the controller 12 may compare a sensing value of a signal from the reuse detection sensor with a first reference range within which the first color is included, and may determine that the stick S is not a reused stick when the sensing value is within the first reference range. For example, the controller 12 may compare a sensing value of a signal from the reuse detection sensor with a second reference range within which the second color is included, and may determine that the stick S is a reused stick when the sensing value is within the second reference range. Upon determining that the stick S is a reused stick, the controller 12 may interrupt the supply of power to the cartridge heater 24 and/or the heater 18.

The controller 12 may determine whether the cartridge 19 is coupled and/or removed using the cartridge detection sensor 135. For example, the controller 12 may determine whether the cartridge 19 is coupled and/or removed based on a sensing value of a signal from the cartridge detection sensor.

The controller 12 may determine whether the aerosol-generating substance in the cartridge 19 is exhausted. For example, the controller 12 may apply power to preheat the cartridge heater 24 and/or the heater 18, and may determine whether the temperature of the cartridge heater 24 exceeds a limit temperature in a preheating section. When the temperature of the cartridge heater 24 exceeds the limit temperature, the controller 12 may determine that the aerosol-generating substance in the cartridge 19 has been exhausted. Upon determining that the aerosol-generating substance in the cartridge 19 has been exhausted, the controller 12 may interrupt the supply of power to the cartridge heater 24 and/or the heater 18.

The controller 12 may determine whether use of the cartridge 19 is possible. For example, upon determining, based on the data stored in the memory 17, that the current number of puffs is equal to or greater than the maximum number of puffs set for the cartridge 19, the controller 12 may determine that use of the cartridge 19 is impossible. For example, when a total time period during which the cartridge heater 24 is heated is equal to or longer than a predetermined maximum time period or when the total amount of power supplied to the cartridge heater 24 is equal to or greater than a predetermined maximum amount of power, the controller 12 may determine that use of the cartridge 19 is impossible.

The controller 12 may make a determination as to a user puff using the puff sensor 132. For example, the controller 12 may determine, based on a sensing value of a signal from the puff sensor, whether a puff occurs. For example, the controller 12 may determine the intensity of a puff based on a sensing value of a signal from the puff sensor 132. When the number of puffs reaches a predetermined maximum number of puffs or when no puff is detected for a predetermined time period or longer, the controller 12 may interrupt the supply of power to the cartridge heater 24 and/or the heater 18.

The controller 12 may determine whether the upper case is coupled and/or removed using the upper case detection sensor 136. For example, the controller 12 may determine, based on a sensing value of a signal from the upper case detection sensor, whether the upper case is coupled and/or removed.

The controller 12 may control the output unit 14 based on a result of detection by the sensor 13. For example, when the number of puffs counted through the puff sensor 132 reaches a predetermined number, the controller 12 may notify the user that operation of the aerosol-generating device 1 will end soon through at least one of the display 141, the haptic unit 142, or the sound output unit 143. For example, upon determining that the stick S is not present in the insertion space, the controller 12 may notify the user of the determination result through the output unit 14. For example, upon determining that the cartridge 19 and/or the upper case has not been mounted, the controller 12 may notify the user of the determination result through the output unit 14. For example, the controller 12 may transmit information about the temperature of the cartridge heater 24 and/or the heater 18 to the user through the output unit 14.

Upon determining that a predetermined event has occurred, the controller 12 may store a history of the corresponding event in the memory 17 and may update the history. The event may include events performed in the aerosol-generating device 1, such as detection of insertion of the stick S, commencement of heating of the stick S, detection of puff, termination of puff, detection of overheating of the cartridge heater 24 and/or the heater 18, detection of application of overvoltage to the cartridge heater 24 and/or the heater 18, termination of heating of the stick S, on/off operation of the aerosol-generating device 1, commencement of charging of the power supply 11, detection of overcharging of the power supply 11, and termination of charging of the power supply 11. The history of the event may include the occurrence date and time of the event and log data corresponding to the event. For example, when the predetermined event is detection of insertion of the stick S, the log data corresponding to the event may include data on a value detected by the insertion detection sensor 133. For example, when the predetermined event is detection of overheating of the cartridge heater 24 and/or the heater 18, the log data corresponding to the event may include data on the temperature of the cartridge heater 24 and/or the heater 18, the voltage applied to the cartridge heater 24 and/or the heater 18, and the current flowing through the cartridge heater 24 and/or the heater 18.

The controller 12 may perform control for formation of a communication link with an external device such as a user's mobile terminal. Upon receiving data on authentication from an external device via the communication link, the controller 12 may release restriction on use of at least one function of the aerosol-generating device 1. Here, the data on authentication may include data indicating completion of user authentication for the user corresponding to the external device. The user may perform user authentication through the external device. The external device may determine, based on the user's birthday or an identification number indicating the user, whether the user data is valid, and may receive data on the authority for use of the aerosol-generating device 1 from an external server. The external device may transmit data indicating completion of user authentication to the aerosol-generating device 1 based on the data on the use authority. When the user authentication is completed, the controller 12 may release restriction on use of at least one function of the aerosol-generating device 1. For example, when the user authentication is completed, the controller 12 may release restriction on use of a heating function for supplying power to the heater 18.

The controller 12 may transmit data on the state of the aerosol-generating device 1 to the external device through the communication link established with the external device. Based on the received state data, the external device may output the remaining capacity of the power supply 11 or the operation mode of the aerosol-generating device 1 through a display of the external device.

The external device may transmit a location search request to the aerosol-generating device 1 based on an input for commencement of search for the location of the aerosol-generating device 1. Upon receiving the location search request from the external device, the controller 12 may perform control, based on the received location search request, such that at least one of the output devices performs operation corresponding to location search. For example, the haptic unit 142 may generate vibration in response to the location search request. For example, the display 141 may output objects corresponding to location search and termination of search in response to the location search request.

Upon receiving firmware data from the external device, the controller 12 may perform control such that the firmware is updated. The external device may check the current version of the firmware of the aerosol-generating device 1 and may determine whether there is a new version of firmware. Upon receiving an input requesting firmware download, the external device may receive new version of firmware data and may transmit the new version of firmware data to the aerosol-generating device 1. Upon receiving the new version of firmware data, the controller 12 may perform control such that the firmware of the aerosol-generating device 1 is updated.

The controller 12 may transmit data on a value detected by the at least one sensor 13 to an external server (not shown) through the communication unit 16, and may receive, from the server, and store a learning model generated by learning the detected value through machine learning such as deep learning. The controller 12 may perform operation of determining the user's puff pattern and operation of generating the temperature profile using the learning model received from the server. The controller 12 may store data on the value detected by the at least one sensor 13 and data for training an artificial neural network (ANN) in the memory 17. For example, the memory 17 may store a database for each of the components provided in the aerosol-generating device 1 and weights and biases constituting the structure of the artificial neural network (ANN) in order to train the artificial neural network (ANN). The controller 12 may learn data on the value detected by the at least one sensor 13, the user's puff pattern, and the temperature profile, which are stored in the memory 17, and may generate at least one learning model used to determine the user's puff pattern and to generate the temperature profile.

As described above, according to at least one of the embodiments of the present disclosure, since the heater made of a carbonaceous material is employed, it is possible to reduce a time required to heat the heater and to increase user satisfaction.

According to at least one of the embodiments of the present disclosure, since the resistance of the heater is measured while applying a voltage having a constant magnitude to the heater, it is possible to accurately measure the temperature of the heater.

According to at least one of the embodiments of the present disclosure, since the length of the section in which the temperature of the heater is measured is set to be short, it is possible to minimize the influence of measurement of the temperature of the heater on heating operation of the heater.

According to at least one of the embodiments of the present disclosure, since a voltage having a constant magnitude applied to the heater is set corresponding to the voltage applied in the heater heating section, it is possible to minimize the influence of measurement of the temperature of the heater on heating operation of the heater.

According to at least one of the embodiments of the present disclosure, since the heat diffusion part is disposed on the outer side of the heater, it is possible to diffuse heat generated unevenly from the heater and to reduce dissipation of the heat generated from the heater to the outside of the heater, thereby increasing the heating efficiency of the aerosol-generating device.

Referring to FIGS. 1 to 15, an aerosol-generating device 1 in accordance with one aspect of the present disclosure may include a body 10, a heater 18 disposed in the body 10 and including a carbonaceous material, a power supply 11 configured to supply power to the heater 18, and a controller 12 configured to control power supplied to the heater 18. The controller 12 may determine the temperature of the heater 18 based on the resistance value of the heater 18 determined in a first section P1, and may control power supplied to the heater 18 to heat the heater 18 in a second section P2 different from the first section P1.

In addition, in accordance with another aspect of the present disclosure, the first section P1 and the second section P2 may be alternately repeated, and the controller 12 may determine power to be supplied to the heater 18 in a second section P2 subsequent to the first section P1 based on the temperature of the heater 18 determined in the first section P1.

In addition, in accordance with another aspect of the present disclosure, the resistance value or the heater 18 varies depending on the temperature of the heater 18, and the controller 12 may determine the temperature of the heater 18 based on the temperature coefficient of resistance of the heater 18.

In addition, in accordance with another aspect of the present disclosure, in the first section P1, the controller 12 may control the power supply 11 to apply a first voltage Va having a constant magnitude to the heater 18.

In addition, in accordance with another aspect of the present disclosure, the first voltage Va may correspond to an output voltage of the power supply 11.

In addition, in accordance with another aspect of the present disclosure, the first voltage Va may be higher than or equal to 3.2 V and lower than or equal to 4.3 V.

In addition, in accordance with another aspect of the present disclosure, the controller 12 may determine the first voltage Va based on a voltage Vb applied to the heater 18 in a second section P2 prior to the first section P1.

In addition, in accordance with another aspect of the present disclosure, the controller 12 may determine an average voltage Vavg applied to the heater 18 in the second section P2 prior to the first section P1, and may determine the first voltage Va based on the determined average voltage Vavg.

In addition, in accordance with another aspect of the present disclosure, the second section P2 may have a length longer than the length of the first section P1.

In addition, in accordance with another aspect of the present disclosure, a ratio of the length of the second section P2 to the length of the first section P1 may be greater than 50:1.

In addition, in accordance with another aspect of the present disclosure, the carbonaceous material may include at least one of graphene or carbon nanotubes.

In addition, in accordance with another aspect of the present disclosure, the body 10 may include an insertion space 43 having an open end, and the heater 18 may be formed in a cylindrical shape to surround the periphery of the insertion space 43.

In addition, in accordance with another aspect of the present disclosure, the aerosol-generating device may further include a heat diffusion part 188 disposed on an outer side of the heater 18 so as to be in contact with at least a portion of the heater 18.

In addition, in accordance with another aspect of the present disclosure, the heat diffusion part 188 may include at least one of a hollow graphite sheet, a vacuum tube, or a heat pipe.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a body;
a heater disposed in the body and comprising a carbonaceous material;
a power supply configured to supply power to the heater; and
a controller configured to control power supplied to the heater,
wherein the controller is configured to:
determine a temperature of the heater based on a resistance value of the heater determined in a first section, and control power supplied to the heater to heat the heater in a second section different from the first section.

2. The aerosol-generating device according to claim 1, wherein the first section and the second section are alternately repeated, and
wherein the controller is configured to determine power to be supplied to the heater in a second section subsequent to the first section based on the temperature of the heater determined in the first section.

3. The aerosol-generating device according to claim 1, wherein a resistance value of the heater varies depending on a temperature of the heater, and
wherein the controller is configured to determine a temperature of the heater based on a temperature coefficient of resistance of the heater.

4. The aerosol-generating device according to claim 1, wherein, in the first section, the controller is configured to control the power supply to apply a first voltage having a constant magnitude to the heater.

5. The aerosol-generating device according to claim 4, wherein the first voltage corresponds to an output voltage of the power supply.

6. The aerosol-generating device according to claim 4, wherein the first voltage is higher than or equal to 3.2 V and lower than or equal to 4.3 V.

7. The aerosol-generating device according to claim 4, wherein the controller is configured to determine the first voltage based on a voltage applied to the heater in a second section prior to the first section.

8. The aerosol-generating device according to claim 7, wherein the controller is configured to determine an average voltage applied to the heater in the second section prior to the first section, and determine the first voltage based on the determined average voltage.

9. The aerosol-generating device according to claim 1, wherein the second section has a length longer than a length of the first section.

10. The aerosol-generating device according to claim 9, wherein a ratio of the length of the second section to the length of the first section is greater than 50:1.

11. The aerosol-generating device according to claim 1, wherein the carbonaceous material comprises at least one of graphene or carbon nanotubes.

12. The aerosol-generating device according to claim 1, wherein the body comprises an insertion space having an open end, and
wherein the heater is formed in a cylindrical shape to surround a periphery of the insertion space.

13. The aerosol-generating device according to claim 12, further comprising a heat diffusion part disposed on an outer side of the heater so as to be in contact with at least a portion of the heater.

14. The aerosol-generating device according to claim 13, wherein the heat diffusion part comprises at least one of a hollow graphite sheet, a vacuum tube, or a heat pipe.
